(19) United States
(12) Patent Application Publication
(10) Pub. No.: US 2014/0136141 A1
(43) Pub. Date: May 15, 2014

(54) SYSTEM AND METHOD OF MOTION TRAJECTORY RECONSTRUCTION

(71) Applicant: National Central University, (US)

(72) Inventors: Min-Chun PAN, Taoyuan County (TW); Chi-Tai YANG, New Taipei City (TW); Chao-Min WU, New Taipei City (TW)

(73) Assignee: NATIONAL CENTRAL UNIVERSITY, TAOYUAN COUNTY (TW)

(21) Appl. No.: 13/714,429

(22) Filed: Dec. 14, 2012

(30) Foreign Application Priority Data
Nov. 14, 2012 (TW) 101142395

(51) Int. Cl. G06F 3/03; G06F 3/01

(52) U.S. Cl. CPC G06F 3/03; G06F 3/017
USPC 702/141

(57) ABSTRACT

A method of motion trajectory reconstruction is described as follows: obtaining angular velocity time-domain data and linear acceleration time-domain data from a traveling inertial sensor; performing a spectrum analysis to transform the angular velocity time-domain data into angular velocity frequency-domain data; choosing a main frequency wave of the spectrum from the angular velocity frequency-domain data; transforming the angular velocity frequency-domain data only having the main frequency wave into angular displacement time-domain data; obtaining linear displacement time-domain data by calculating the linear acceleration time-domain data and the angular displacement time-domain data; and reconstructing and displaying the motion trajectory of the inertial sensor according to the linear displacement time-domain data and the angular displacement time-domain data.

### RELATED APPLICATIONS

This application claims priority to Taiwan Application Serial Number 101142395, filed Nov. 14, 2012, which is herein incorporated by reference.

### BACKGROUND

1. Field of Invention

The invention relates to a method of motion trajectory reconstruction. particularly, the invention relates to a system and a method of motion trajectory reconstruction based on an inertial sensing signal.

2. Description of Related Art

To contribute to the development of biotechnology health care, human body rehabilitation or even intelligence-beneficial entertainment field, researchers have certain motivation to reconstruct the motion trajectory of human limb for subsequent study. In particularly, the researchers configure an inertial sensor on the human limb. When the human limb moves, displacement data of limb movement can be calculated from the inertial sensing signal (such as a linear acceleration signal and an angular acceleration signal) recorded by the inertial sensor, thereby achieving the motion trajectory reconstruction.

In all traditional manners of motion trajectory reconstruction, angular displacement and linear displacement of motion are calculated through direct numerical integration of time-domain data of these inertial sensing signals, and then a subsequent coordinate transform is performed.

However, since an original signal recorded by the inertial sensor still contains noise, after the abovementioned numerical integration, the noise is also magnified and accumulated at the same time. Therefore, if the subsequent coordinate transform is then performed directly, an accumulated shift of an original motion trajectory is caused and the accuracy of the reconstructed motion trajectory is reduced, so that the subsequent research depending on the data is distorted.

Therefore, can be seen from the above description that, some difficulties and challenges to be overcome are still existed during the motion trajectory reconstruction of the human limb.

### SUMMARY

In view of this, a system and a method of motion trajectory reconstruction are provided in embodiments of the invention to overcome the above difficulties and challenges.

The invention provides a system and a method of motion trajectory reconstruction for effectively enhancing the accuracy of the trajectory reconstruction.

The invention further provides a system and a method of motion trajectory reconstruction for effectively omitting noise.

For achieving the above purposes, in an aspect, a system and a method of motion trajectory reconstruction are disclosed in an embodiment of the invention. The motion trajectory reconstruction system includes multiple inertial sensors, a screen and a computer device. The inertial sensors are used for collecting at least angular velocity time-domain data and linear acceleration time-domain data. The computer device is electrically connected to the inertial sensors and the screen for obtaining the angular velocity time-domain data and the linear acceleration time-domain data from a traveling inertial sensor; performing a spectrum analysis to transform each of the angular velocity time-domain data into angular velocity frequency-domain data; identifying a main frequency wave and a redundant frequency wave in a spectrum of frequency-domain data and choosing the main frequency wave, wherein the frequency-domain data is the angular velocity frequency-domain data or angular displacement frequency-domain data transformed from the angular velocity frequency-domain data; transforming the angular velocity frequency-domain data only having the main frequency wave or the angular displacement frequency-domain data into angular displacement time-domain data; obtaining linear displacement time-domain data by calculating the linear acceleration time-domain data and the angular displacement time-domain data; and reconstructing and displaying the motion trajectory of the inertial sensor on the screen according to the linear displacement time-domain data and the angular displacement time-domain data.

This method of motion trajectory reconstruction is applied to the above motion trajectory reconstruction system, and steps of the method are described as follows: obtaining at least angular velocity time-domain data and linear acceleration time-domain data from a traveling inertial sensor; performing a spectrum analysis to transform the angular velocity time-domain data into angular velocity frequency-domain data, wherein frequency content and corresponding amplitude and phase information of the angular velocity frequency-domain data are obtained from the spectrum of the angular velocity frequency-domain data; identifying a main frequency wave and a redundant frequency wave in the spectrum of the angular velocity frequency-domain data and choosing the main frequency wave; transforming the angular velocity frequency-domain data only having the main frequency wave into angular displacement time-domain data; obtaining linear displacement time-domain data by calculating the linear acceleration time-domain data and the angular displacement time-domain data; and reconstructing and displaying the motion trajectory of the inertial sensor according to the linear displacement time-domain data and the angular displacement time-domain data.

In another aspect, a method of motion trajectory reconstruction applied to the above motion trajectory reconstruction system is disclosed in another embodiment of the invention, and steps of the method are described as follows: obtaining at least angular velocity time-domain data and linear acceleration time-domain data from a traveling inertial sensor; performing a spectrum analysis to transform the angular velocity time-domain data into angular velocity frequency-domain data; transforming the angular velocity frequency-domain data into angular displacement frequency-domain data, wherein frequency content and corresponding amplitude and phase information of the angular displacement frequency-domain data are obtained from a spectrum of the angular displacement frequency-domain data; identifying a main frequency wave and a redundant frequency wave in the spectrum of the angular displacement frequency-domain data and choosing the main frequency wave; transforming the angular displacement frequency-domain data only having the main frequency wave into angular displacement time-domain data; obtaining linear displacement time-domain data by calculating the linear acceleration time-domain data and the angular displacement time-domain data; and reconstructing and displaying the motion trajectory of the inertial sensor according to the linear displacement time-domain data and the angular displacement time-domain data.

In other aspects, a computer readable recording medium internally-storing a program is also disclosed in an embodiment of the invention. When the program is loaded into and executed in a computer, a method of motion trajectory reconstruction as described above can be achieved.

It can be seen from the above description that, the invention can perform the spectrum analysis to decompose a signal into a sinusoidal combination with different frequencies, and then a frequency (including an amplitude and a phase) representing a main and obvious action is chosen and a frequency component unrelated to a specific action or originated from measured noise is omitted, so as to effectively enhance the accuracy of the trajectory reconstruction.

The above description is only used for illustrating aspects of the invention, technical means for achieving the aspects, functions of the technical means and other advantages of the invention, etc., and details of the invention will be described in the Detailed Description with reference to related drawings hereinafter.

### BRIEF DESCRIPTION OF THE DRAWINGS

In order to make the foregoing as well as other aspects, features, advantages and embodiments of the invention more apparent, the accompanying drawings are described as follows:

FIG. 1 is a flow chart of a method of motion trajectory reconstruction of the invention;

FIG. 2 is a schematic block diagram of a motion trajectory reconstruction system in which the method of motion trajectory reconstruction of the invention is executed;

FIG. 3 is a detailed flow chart of the method of motion trajectory reconstruction in a first embodiment of the invention;

FIG. 4 is a schematic diagram of inertial sensors configured on the human arm;

FIG. 5A is a schematic coordinate diagram shown for the method of motion trajectory reconstruction of the invention;

FIG. 5B is a schematic spectrum diagram shown for the method of motion trajectory reconstruction of the invention;

FIG. 6 is a detailed flow chart of the method of motion trajectory reconstruction in a second embodiment of the invention;

FIG. 7 is a detailed flow chart of the method of motion trajectory reconstruction in a third embodiment of the invention; and

FIG. 8 is a detailed flow chart of the method of motion trajectory reconstruction in a fourth embodiment of the invention.

### DETAILED DESCRIPTION

The spirit of the invention is described clearly in the following detailed description with reference to the drawings. After those of skills in the art learn the embodiments of the invention, variations and modifications can be made from the techniques taught in the invention without departing from the spirit and scope of the invention.

The main spirit of the invention is transforming a time-domain signal into a frequency-domain signal (such as an angular velocity frequency-domain signal, an angular displacement frequency-domain signal, a linear acceleration frequency-domain signal and a linear displacement frequency-domain signal) and then choosing a main frequency wave (including the amplitude and the phase) representing the main and obvious action through the sinusoidal combination with different amplitudes in the presented spectrum of the frequency-domain signal, and omitting the redundant frequency wave unrelated to the specific action or originated from the measured noise, so as to effectively enhance the accuracy of the trajectory reconstruction.

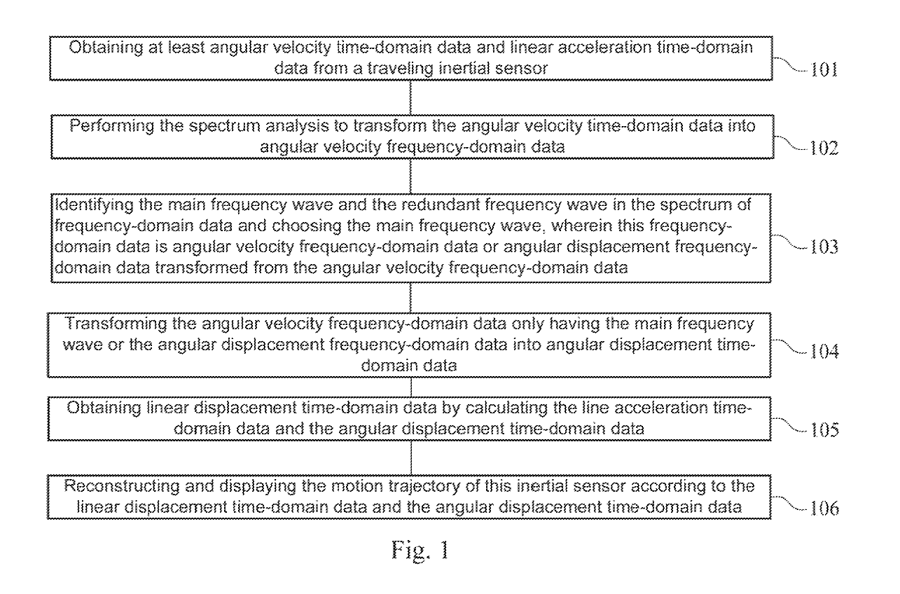

As shown in FIG. 1, it is a flow chart of a method of motion trajectory reconstruction of the invention.

As shown in the figure, the method of motion trajectory reconstruction is described as follows. In step 101 at least angular velocity time-domain data and linear acceleration time-domain data are obtained from a traveling inertial sensor. In step 102, the spectrum analysis is performed to transform the angular velocity time-domain data into angular velocity frequency-domain data. In step 103, the main frequency wave and the redundant frequency wave in the spectrum of frequency-domain data is identified and the main frequency wave is chosen, wherein this frequency-domain data is angular velocity frequency-domain data or angular displacement frequency-domain data transformed from the angular velocity frequency-domain data. In step 104, the angular velocity frequency-domain data only having the main frequency wave or the angular displacement frequency-domain data is transformed into angular displacement time-domain data. In step 105, linear displacement time-domain data is obtained by calculating the linear acceleration time-domain data and the angular displacement time-domain data. In step 106, the motion trajectory of the inertial sensor is reconstructed and displayed according to the linear displacement time-domain data and the angular displacement time-domain data.

Therefore, the method of motion trajectory reconstruction of the invention can be widely applied to reconstruct continuous periodic motion trajectories for any moving body such as the human limb (e.g., an arm, a shoulder, an elbow, a wrist) or an animal limb (e.g., a leg, a tail) or a mechanical moving member (e.g., a motor). For convenience of illustration, an arm convolution motion is taken as an example in the detailed description of the following embodiments. That is, an inertial sensing element is mostly configured on the arm in the following embodiments. However, those of skills in the art should know that, the following embodiments are only used for helping illustration, rather than limiting the invention to the trajectory reconstruction of the arm.

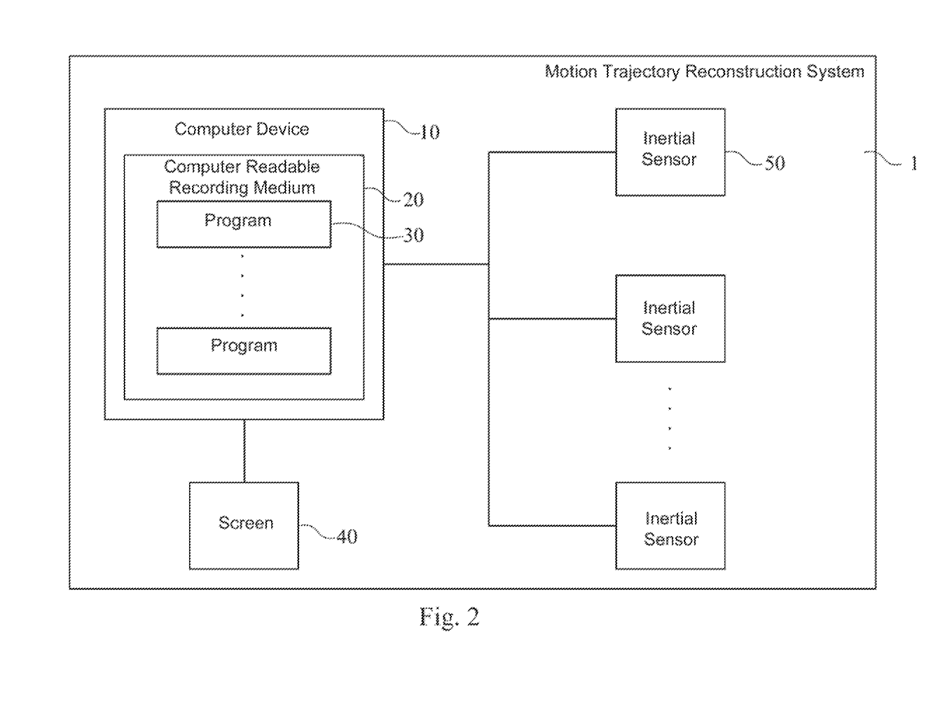

Referring to FIG. 2, it is a schematic block diagram of a motion trajectory reconstruction system in which the method of motion trajectory reconstruction of the invention is executed.

A motion trajectory reconstruction system 1 includes a computer device 10, multiple inertial sensors 50 and a screen 40. The computer device 10 is electrically connected to the inertial sensors 50 and the screen 40. A computer readable recording medium 20 is configured within the computer device 10. For example, the computer readable recording medium 20 may include, but not limited to, a hard disk, floppy disk, flash drive, CD-ROM, DVD, Blue-ray DVD, etc. At least a program 30 is stored in the computer readable recording medium 20. The method of motion trajectory reconstruction may take the form of a computer program product (e.g. computer readable recording medium 20) stored on the computer-readable storage medium (e.g. program 30) having computer-readable instructions embodied in the medium. When the program 30 is loaded into and executed on a computer, the above method of motion trajectory reconstruction can be performed. Any suitable storage medium may be used. In some embodiments, such suitable storage medium may be a non-transitory computer readable storage medium including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HOD) and floppy disk drives. In other embodiments, other suitable storage mediums may be used, which should not be limited in this invention.

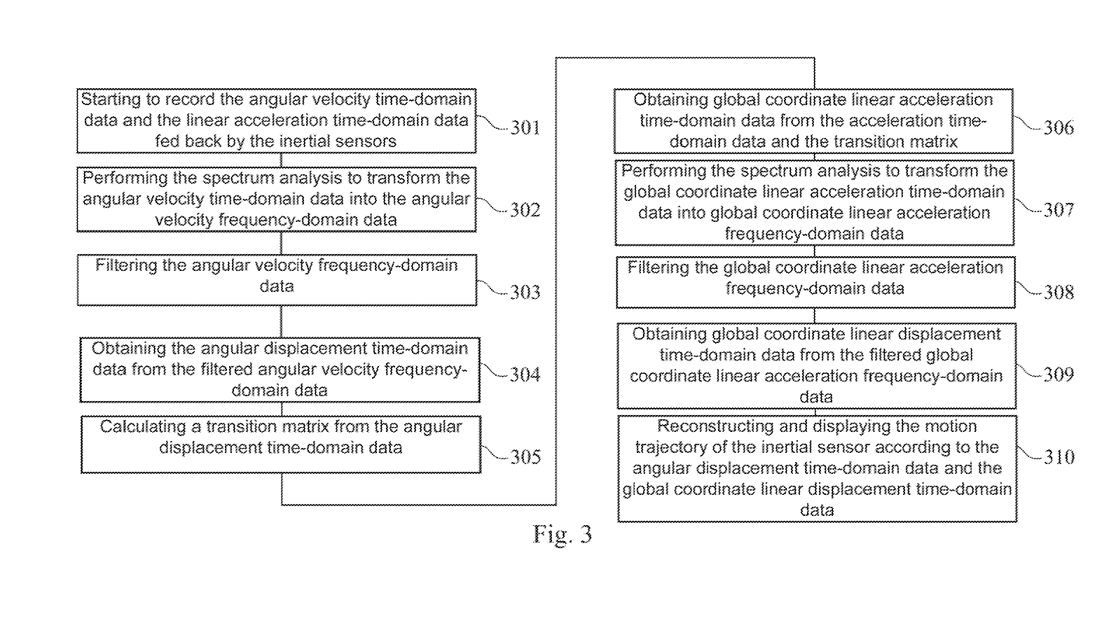

As shown in FIG. 3, it is detailed flow chart of the method of motion trajectory reconstruction in a first embodiment of the invention.

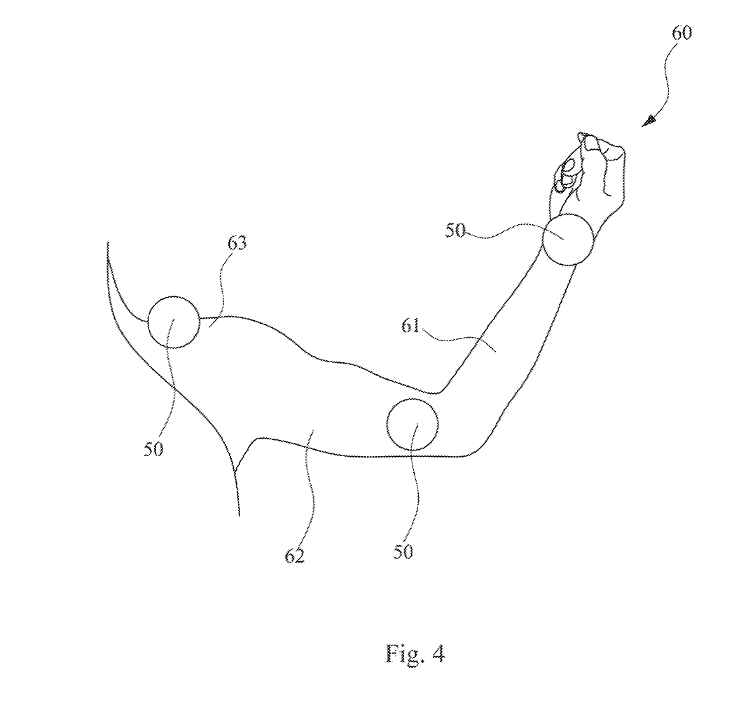

The inertial sensors 50 are firstly configured before the flow chart starts (referring to FIG. 4). For example, multiple inertial sensors 50 are configured on a fore arm 61, an upper arm 62 and a shoulder 63 of a human arm 60, so that when a convolution motion of the human arm 60 is performed, an inertial sensing signal can be emitted continuously in real time by each of the configured inertial sensors 50. The inertial sensing signal contains linear acceleration data (or referred to as a signal) and angular velocity data (or referred to as a signal). The inertial sensor 50, for example, contains a tri-axial accelerometer and a tri-axial gyroscope. The accelerometer is used for measuring and recording the (linear) acceleration generated in the process of arm motion, and the gyroscope is used for measuring the angular velocity generated in motion.

In addition, after the inertial sensors are configured on the human arm, the human arm can he raised in a horizontal direction to calibrate the inertial sensors, so as to for example determine whether each inertial sensor has a value less than one gravity acceleration (g) in a Z-axis direction, and if no error, the convolution motion of the human arm is started.

In step 301, the angular velocity time-domain data and the linear acceleration time-domain data fed back by the inertial sensors start to be recorded. More specifically, in the step 301, when a continuous convolution motion of the human arm is performed, inertial sensing data sequentially outputted by the inertial sensors 50 starts to be recorded. An angular velocity equation and a linear acceleration equation are derived from the inertial sensing data of each position by using the kinematics, so as to simulate the angular velocity time-domain data and the linear acceleration time-domain data at a relative coordinate generated during limb motion. Since the angular velocity equation and the linear acceleration equation are known, a calculation relating to the angular velocity time-domain data and the linear acceleration time-domain data at the relative coordinate is not illustrated any further herein.

In step 302, the spectrum analysis is performed to transform the angular velocity time-domain data into the angular velocity frequency-domain data. Specifically, a means of performing the spectrum analysis to transform the angular velocity time-domain data into the angular velocity frequency-domain data may be, for example, a discrete Fourier Transform (FT), a discrete Wavelet Transform (WT) or other data transforms capable of presenting spectrum information.

For example, the signal is decomposed by the discrete Fourier Transform into the sinusoidal combination with different frequencies, and a kind of time-domain data is transformed into a kind of frequency-domain data for observing characteristic of the kind of data. A definition (equation A) of the Fourier Transform is represented as follows:

F(ω)=∫_{-∞}^{∞}f(t)e^{-jωe}dt

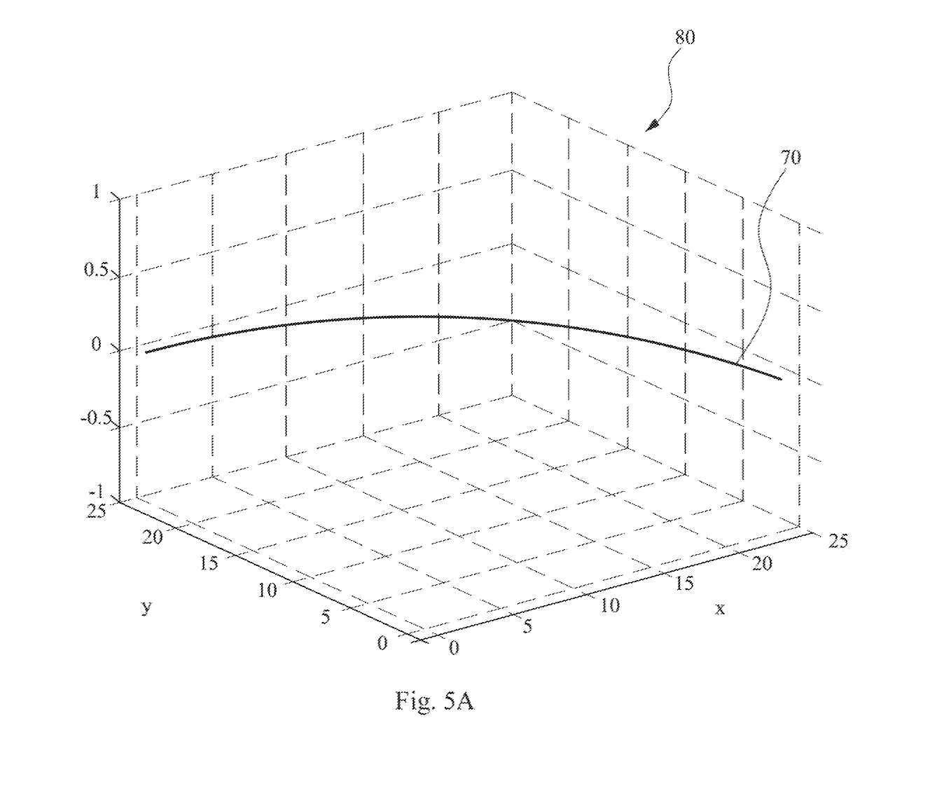

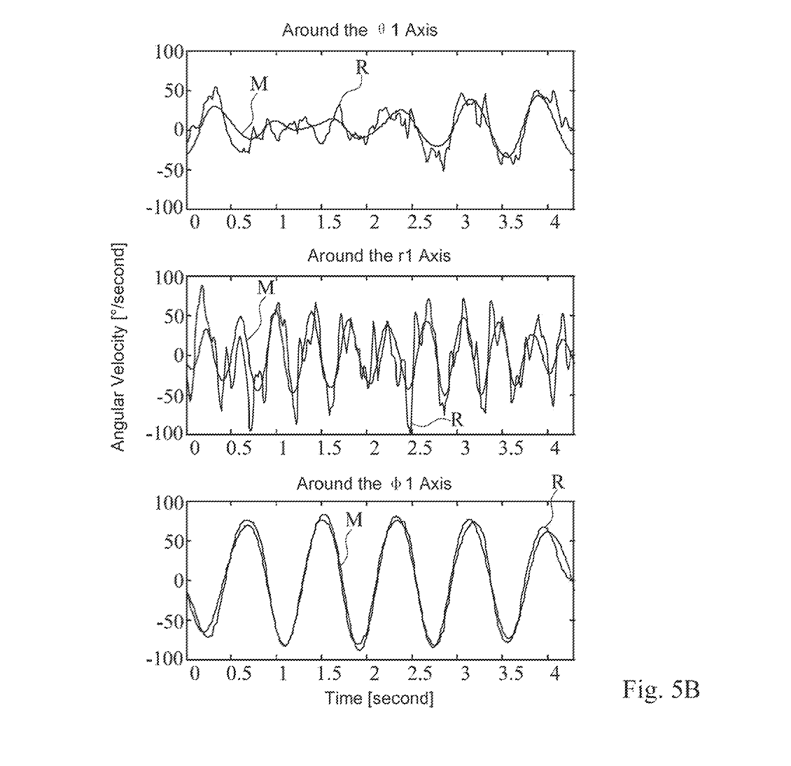

In step 303, the angular velocity frequency-domain data is filtered. Since the frequency, amplitude and phase of an original time-domain signal can be obtained from the angular velocity frequency-domain data from which a spectrum diagram and a phase diagram can be drawn, a main frequency wave M and a redundant frequency wave R (as shown in FIG. 5B) can be identified from the spectrum of the angular velocity frequency-domain data, and a certain main frequency wave M is chosen. The main frequency wave represents the frequency (including the amplitude and the phase) representing the obvious action, and the redundant frequency wave represents the frequency component unrelated to the specific action or originated from the measured noise. Since the spectrum can be displayed by the screen 40 of the system 1 the researchers can identify the main frequency wave and the redundant frequency wave from the spectrum. However, the invention is not limited to this, and the manner of identifying the main frequency wave and the redundant frequency wave from the spectrum of the angular velocity frequency-domain data also can be determined by the program 30 in the system 1.

Therefore, when a certain main frequency wave is chosen from the spectrum and the redundant frequency wave therein is omitted, of which the process is also referred to as filtering of the angular velocity frequency-domain data, the filtered angular velocity frequency-domain data is the angular velocity frequency-domain data only having the main frequency wave.

In step 304, the angular displacement time-domain data (i.e., the angular displacement value) is obtained from the filtered angular velocity frequency-domain data.

In this step, the angular velocity frequency-domain data only having the main frequency wave is substituted into a sine function reconstruction equation, so as to obtain the angular displacement time-domain data (i.e., the angular displacement value). The sine function reconstruction equation can be represented by the following equation (equation B):

$$\frac{A}{ω} sin ( ω t + φ + 90 ° ) .$$

wherein, A represents the amplitude of a certain main frequency wave, ω represents the frequency, φ represents the phase, and t represents time.

Therefore, since the redundant frequency wave of the angular velocity frequency-domain data has been filtered from the filtered angular velocity frequency-domain data, a more accurate result of the angular displacement time-domain data can be calculated from the filtered angular velocity frequency-domain data, thereby reducing noise accumulation and enhancing the accuracy of the calculated angular displacement time-domain data.

In step 305, a transition matrix is calculated from the angular displacement time-domain data. Specifically, the step 305 includes two sub-steps: calculating a quaternion value from the angular displacement time-domain data; and calculating the transition matrix from the quaternion value. When the quaternion value is calculated from the angular displacement time-domain data, the angular displacement time-domain data is substituted into a quaternion algorithm to calculate the quaternion value. Four variables of a quaternion number are defined as follows:

$$q = [ \begin{matrix}{q}_{0} \\ {q}_{1} \\ {q}_{2} \\ {q}_{3}\end{matrix} ] \vert$$

wherein, the quaternion number does not have four degrees of freedom, and the following constraint condition should be satisfied:

q₀²+q₁²+q₂²+q₃²=1.

When rotation is performed, variation of he quaternion number satisfies the following {dot over ( q̅=½ ω̅ [symbol] q̅| relational expression (equation C):

wherein, {dot over ( q̅ represents a first derivative differential of the quaternion number, ω̅ represents the angular velocity in a tri-axial direction at the relative coordinate, [symbol] | represents a quaternion multiplication. Therefore, the above equation can be represented with a matrix form as the following equation (equation D):

$$[ \begin{matrix}{\dot{q}}_{0} \\ {\dot{q}}_{1} \\ {\dot{q}}_{2} \\ {\dot{q}}_{3}\end{matrix} ] = \frac{1}{2} [ \begin{matrix}0 & - {ω}_{θ} & - {ω}_{r} & - {ω}_{ϕ} \\ {ω}_{θ} & 0 & {ω}_{ϕ} & - {ω}_{r} \\ {ω}_{r} & - {ω}_{ϕ} & 0 & {ω}_{θ} \\ {ω}_{ϕ} & {ω}_{r} & - {ω}_{θ} & 0\end{matrix} ] [ \begin{matrix}{q}_{0} \\ {q}_{1} \\ {q}_{2} \\ {q}_{3}\end{matrix} ]$$

Since the matrix formed by angular velocities in the above equation is not a constant matrix, an analytical solution cannot be obtained, but the above equation can be transformed into the following equation (equation E) to obtain the quaternion number:

$${[ \begin{matrix}{q}_{0} \\ {q}_{1} \\ {q}_{2} \\ {q}_{3}\end{matrix} ]}_{n + 1} = {\frac{1}{2} [ \begin{matrix}2 & - {Δφ}_{θ} & - {Δφ}_{r} & - {Δφ}_{ϕ} \\ {Δφ}_{θ} & 2 & {Δφ}_{ϕ} & - {Δφ}_{r} \\ {Δφ}_{r} & - {Δφ}_{ϕ} & 2 & {Δφ}_{θ} \\ {Δφ}_{ϕ} & {Δφ}_{r} & - {Δφ}_{θ} & 2\end{matrix} ] [ \begin{matrix}{q}_{0} \\ {q}_{1} \\ {q}_{2} \\ {q}_{3}\end{matrix} ]}_{n} ,$$

wherein, Δφ_{θ}, Δφ_{γ}, Δφ_{φ} each represent the angular displacements at the relative coordinates θ, γ, φ.

When the transition matrix is calculated from the quaternion number, specifically, the quaternion number s substituted into the transition matrix equation (equation F, as shown below) to calculate the transition matrix.

$$T = [ \begin{matrix}{q}_{0}^{2} + {q}_{1}^{2} - {q}_{2}^{2} - {q}_{3}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{0}^{2} - {q}_{1}^{2} + {q}_{2}^{2} - {q}_{3}^{2} & 2 ( {q}_{2} {q}_{3} - {q}_{0} {q}_{1} ) \\ 2 ( {q}_{1} {q}_{3} - {q}_{0} {q}_{2} ) & 2 ( {q}_{2} {q}_{3} + {q}_{0} {q}_{1} ) & {q}_{0}^{2} - {q}_{1}^{2} - {q}_{2}^{2} - {q}_{3}^{2}\end{matrix} ]$$

In step 306, linear acceleration time-domain data at a global coordinate is obtained from the acceleration time-domain data and the transition matrix. In this step, after the linear acceleration time-domain data at the relative coordinate is multiplied by the above transition matrix equation, the global coordinate linear acceleration time-domain data (value) can be obtained. In addition, since the gravity acceleration acts downward towards the Z-axis direction of the global coordinate, 1 g gravity acceleration should be deducted from the global coordinate linear acceleration time-domain data in the Z-axis direction, so as to obtain actual global coordinate linear acceleration time-domain data (value), i.e., the global coordinate linear acceleration generated due to the arm motion.

In step 307, the spectrum analysis is performed to transform the global coordinate linear acceleration time-domain data into global coordinate linear acceleration frequency-domain data. Specifically, the spectrum analysis is performed to transform actual global coordinate linear acceleration time-domain data into global coordinate linear acceleration frequency-domain data. The frequency content and corresponding amplitude and phase information of the linear acceleration frequency-domain data are obtained from the spectrum of the linear acceleration frequency-domain data. Additionally, the means of performing the spectrum analysis to transform the global coordinate linear acceleration time-domain data to the global coordinate linear acceleration frequency-domain data may be, for example, the discrete Fourier Transform (FT), the discrete Wavelet Transform (WT) or other data transforms capable of presenting the spectrum information. The rest can be referred to the step 302, which is not illustrated any further herein.

In step 308, the global coordinate linear acceleration frequency-domain data is filtered to identify and choose the main frequency wave from the spectrum of this actual global coordinate linear acceleration frequency-domain data. The details of the step are identical to the step 303, and thus it is not illustrated any further herein.

In step 309, global coordinate linear displacement time-domain data is obtained from the filtered global coordinate linear acceleration frequency-domain data. In this step, the global coordinate linear acceleration frequency-domain data only having the main frequency wave can he substituted into the above second sine function reconstruction equation (equation C), so as to obtain global coordinate linear displacement time-domain data (i.e., the linear displacement value).

The sine function reconstruction equation can he represented by the following equation (equation C):

$$\frac{A}{{ω}^{2}} sin ( ω t + φ + 180 ° ) .$$

wherein, A represents the amplitude of a certain main frequency wave, ω represents the frequency, φ represents the phase, and t represents time.

Similarly, since the redundant frequency wave of the global coordinate linear acceleration frequency-domain data has been filtered from the filtered global coordinate linear acceleration frequency-domain data, a more accurate result of the global coordinate linear displacement time-domain data can be calculated from the filtered global coordinate linear acceleration frequency-domain data, thereby reducing the noise accumulation and enhancing the accuracy of the calculated global coordinate linear displacement time-domain data.

In step 310, the motion trajectory of the inertial sensor is reconstructed and displayed according to the above obtained angular displacement time-domain data and the global coordinate linear displacement time-domain data. Finally, when the abovementioned angular displacement time-domain data and the global coordinate linear displacement time-domain data are obtained, the motion trajectory reconstruction can be performed by the motion trajectory reconstruction system 1, and the result can be drawn into a coordinate diagram 80 (as shown in FIG. 5A to be displayed in the screen 40.

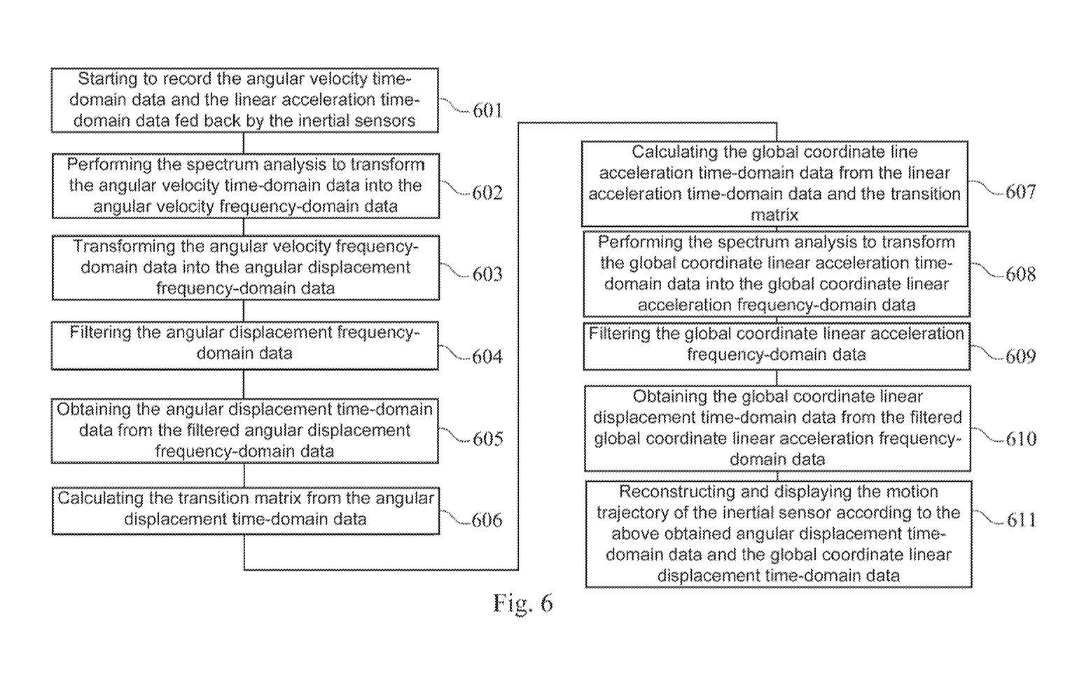

As shown in FIG. 6, it is a detailed flow chart of the method of motion trajectory reconstruction in a second embodiment of the invention.

The inertial sensors 50 are firstly configured before the flow chart starts (referring to FIG. 4). Details can be referred to the above description, which are not illustrated any further herein.

In step 601, the angular velocity time-domain data and the linear acceleration time-domain data fed back by the inertial sensors start to be recorded. In step 602, the spectrum analysis is performed to transform the angular velocity time-domain data into the angular velocity frequency-domain data. Since the steps 601-602 are identical to the steps 301-302 of the first embodiment, these steps are not illustrated any further herein.

In step 603, the angular velocity frequency-domain data is transformed into the angular displacement frequency-domain data. The difference between the step and the first embodiment is that, the angular velocity frequency-domain data is firstly transformed into the angular displacement frequency-domain data and then the angular displacement frequency-domain data is filtered, instead of directly filtering the angular velocity frequency-domain data.

Specifically, transforming the angular velocity frequency-domain data into the angular displacement frequency-domain data is achieved by deriving a sine function reconstruction equation from the above equation B through a derivation way, and the sine function reconstruction equation is represented as follows (equation G):

A sin(ωt+φ)

wherein, A represents the amplitude of the main frequency wave, ω represents the frequency, φ represents the phase, and t represents time.

In step 604, the angular displacement frequency-domain data is filtered. Since the frequency, amplitude and phase of the original time-domain signal can be obtained from the angular displacement frequency-domain data, from which the spectrum diagram and the phase diagram can be drawn, the main frequency wave M and the redundant frequency wave R (as shown in FIG. 5B) can be identified from the spectrum of the angular displacement frequency-domain data, and a certain main frequency wave M is chosen. The main frequency wave represents the frequency (including the amplitude and the phase) of the obvious action, and the redundant frequency wave represents the frequency component unrelated to the specific action or originated from the measured noise. Therefore, it should be understood that, the way of identifying the main frequency wave and the redundant frequency wave from the spectrum of the angular displacement frequency-domain data can be determined by the researchers or from the program. Therefore, when a certain main frequency wave is chosen from the spectrum and the redundant frequency wave therein is omitted, of which the process is also referred to as filtering of the angular displacement frequency-domain data, the filtered angular displacement frequency-domain data is the angular displacement frequency-domain data only having the main frequency wave.

In step 605, the angular displacement time-domain data is obtained from the filtered angular displacement frequency-domain data. In this step, the angular displacement frequency-domain data only having the main frequency wave can be substituted into the equation G (as shown below) to transform into the angular displacement time-domain data.

A sin(ωt+φ)

In the above equation, A represents the amplitude of the main frequency wave, ω represents the frequency, φ represents the phase, and t represents time.

Additionally, the means of transforming the filtered angular displacement frequency-domain data into the angular displacement time-domain data further may be a discrete Inverse Fourier Transform (IFT) or a discrete Inverse Wavelet Transform (IWT) or other data transforms capable of recovering time information.

Therefore, since the redundant frequency wave of the angular displacement frequency-domain data has been filtered from the filtered angular displacement frequency-domain data, a more accurate result of the angular displacement time-domain data can be calculated by recovering from the filtered angular displacement frequency-domain data, thereby reducing the noise accumulation and enhancing the accuracy of the calculated angular displacement time-domain data.

In step 606, the transition matrix is calculated from the angular displacement time-domain data. In step 607, the global coordinate linear acceleration time-domain data is calculated from the linear acceleration time-domain data and the transition matrix. In step 608, the spectrum analysis is performed to transform the global coordinate linear acceleration time-domain data into the global coordinate linear acceleration frequency-domain data. In step 609, the global coordinate linear acceleration frequency-domain data is filtered to identify and choose the main frequency wave in the spectrum of this actual global coordinate linear acceleration frequency-domain data. In step 610, the global coordinate linear displacement time-domain data is obtained from the filtered global coordinate linear acceleration frequency-domain data. In step 611, the motion trajectory of the inertial sensor is reconstructed and displayed according to the above obtained angular displacement time-domain data and the global coordinate linear displacement time-domain data.

Since the steps 606-611 in the second embodiment are identical to the steps 305-310 in the first embodiment, details of the steps 606-611 can be known with reference to the first embodiment, and thus details are not illustrated any further herein.

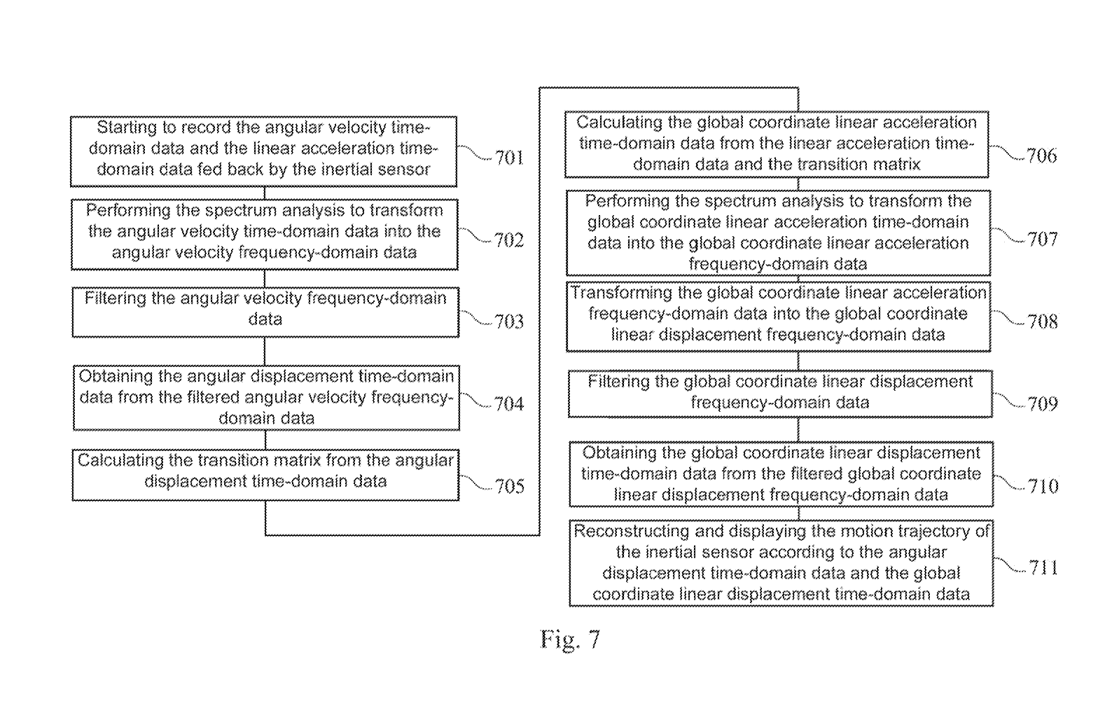

As shown in FIG. 7, it is a detailed flow chart of the method of motion trajectory reconstruction in a third embodiment of the invention.

The third embodiment includes the steps 701-711, wherein in the step 701, the angular velocity time-domain data and the linear acceleration time-domain data fed back by the inertial sensor start to be recorded. In step 702, the spectrum analysis is performed to transform the angular velocity time-domain data into the angular velocity frequency-domain data.

In step 703, the angular velocity frequency-domain data is filtered. In step 704, the angular displacement time-domain data (i.e., the angular displacement value) is obtained from the filtered angular velocity frequency-domain data.

In step 705, the transition matrix is calculated from the angular displacement time-domain data. In step 706, the global coordinate linear acceleration time-domain data is calculated from the linear acceleration time-domain data and the transition matrix. In step 707, the spectrum analysis is performed to transform the global coordinate linear acceleration time-domain data into the global coordinate linear acceleration frequency-domain data.

Since the steps 701-707 and the step 711 are identical to the steps 301-307 and the step 310 in the first embodiment, the details of the steps 701-707 and the step 711 can be known from the first embodiment, and these steps are not illustrated any further herein.

In step 708, the global coordinate linear acceleration frequency-domain data is transformed into the global coordinate linear displacement frequency-domain data. The difference between the step and the first embodiment is that, the global coordinate linear acceleration frequency-domain data is firstly transformed into the global coordinate linear e displacement frequency-domain data and then the global coordinate linear displacement frequency-domain data is filtered, instead of directly filtering the global coordinate linear acceleration frequency-domain data.

Specifically, the above equation C is derived into the equation G by the derivation way.

In step 709, the global coordinate linear displacement frequency-domain data is filtered to identify and choose the main frequency wave from the spectrum of this actual global coordinate linear displacement frequency-domain data. The detail method of the step is identical to the step 303, and thus it is not illustrated any further herein.

In step 710, the global coordinate linear displacement time-domain data is obtained from the filtered global coordinate linear displacement frequency-domain data. In this step, the global coordinate linear acceleration frequency-domain data only having the main frequency wave can be substituted into the sine function reconstruction equation (equation G shown as below), so as to obtain the global coordinate linear displacement time-domain data (i.e., the linear displacement value).

A sin(ωt+φ)

In the above equation, A represents the amplitude of the main frequency wave, ω represents the frequency, φ represents the phase, and t represents time.

Additionally, the means of transforming the filtered global coordinate linear displacement frequency-domain data into the global coordinate linear displacement time-domain data further may be the discrete Inverse Fourier Transform (IFT) or the discrete Inverse Wavelet Transform (IWT) or other data transforms capable of recovering the time information.

Similarly, since the redundant frequency wave of the global coordinate linear displacement frequency-domain data has been filtered from the filtered global coordinate linear displacement frequency-domain data, a more accurate result of the global coordinate linear displacement time-domain data can be calculated from the filtered global coordinate linear displacement frequency-domain data, thereby reducing the noise accumulation and enhancing the accuracy of the calculated global coordinate linear displacement time-domain data.

In step 711, the motion trajectory of the inertial sensor is reconstructed and displayed according to the above obtained angular displacement time-domain data and the global coordinate linear displacement time-domain data. Finally, when the abovementioned angular displacement time-domain data and the global coordinate linear displacement time-domain data are obtained, the motion trajectory reconstruction can be performed by the motion trajectory reconstruction system 1, and the result can be drawn into a coordinate diagram 80 (as shown in FIG. 5A) to be displayed in the screen 40.

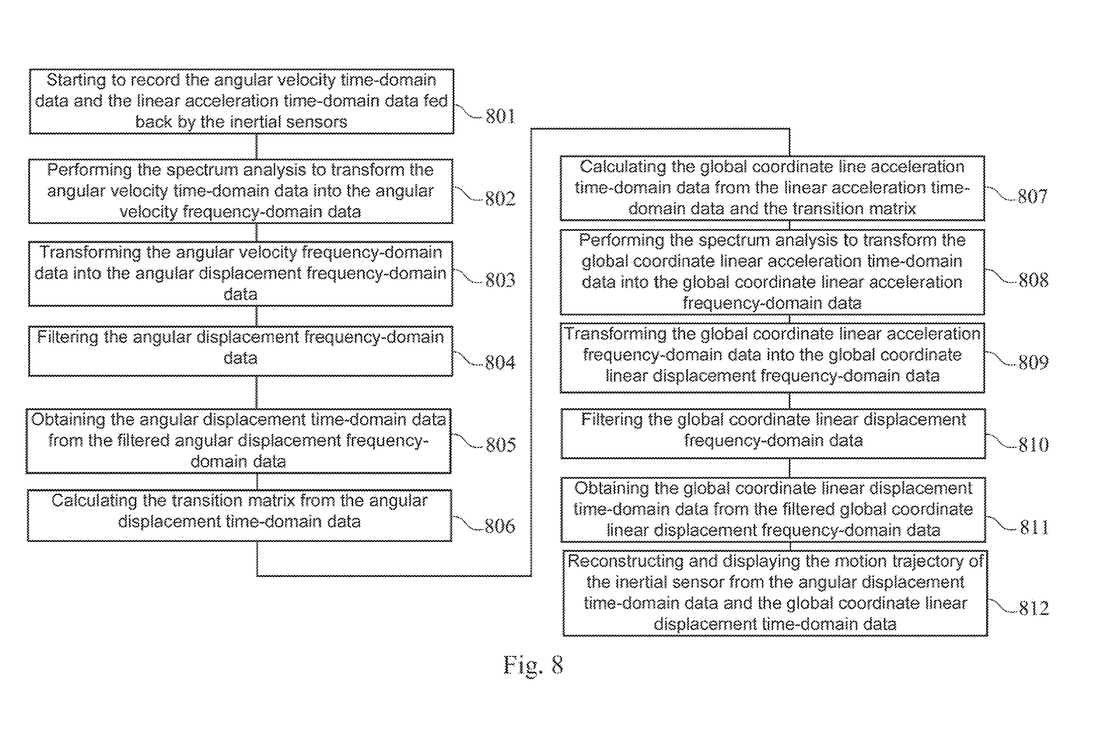

As shown in FIG. 8, it is a detailed flow chart of the method of motion trajectory reconstruction in a fourth embodiment of the invention.

The fourth embodiment includes the steps 801-812, wherein since the steps 801-808 are identical to the steps 601-608 in the second embodiment, and the steps 809-812 are identical to the steps 708-711 in the third embodiment, these steps are not illustrated any further herein.

It can be seen from the above description that, whether the angular velocity frequency-domain data or the angular displacement frequency-domain data, or the linear acceleration frequency-domain data or the linear displacement frequency-domain data is filtered, in the invention the frequency (including the amplitude and the phase) representing the main obvious action can be chosen from the spectrum, and the frequency component unrelated to the specific action or originated from the measured noise can be omitted, thereby obtaining the angular displacement time-domain data and the linear displacement time-domain data required for the trajectory reconstruction, so as to effectively enhance the accuracy of the trajectory reconstruction.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference,

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of motion trajectory reconstruction applied to a motion trajectory reconstruction system, the method comprising:
obtaining at least angular velocity time-domain data and linear acceleration time-domain data from a traveling inertial sensor;
performing a spectrum analysis to transform the angular velocity time-domain data into angular velocity frequency-domain data, wherein frequency content and corresponding amplitude and phase information of the angular velocity frequency-domain data are obtained from a spectrum of the angular velocity frequency-domain data;
identifying a main frequency wave and a redundant frequency wave in the spectrum of the angular velocity frequency-domain data and choosing the main frequency wave;
transforming the angular velocity frequency-domain data only having the main frequency wave into angular displacement time-domain data;
obtaining linear displacement time-domain data by calculating the linear acceleration time-domain data and the angular displacement time-domain data; and
reconstructing and displaying the motion trajectory of the inertial sensor according to the linear displacement time-domain data and the angular displacement time-domain data.

2. The method of motion trajectory reconstruction of claim 1, wherein the step of performing the spectrum analysis for the angular velocity time-domain data further comprises:
performing a discrete Fourier Transform or a discrete Wavelet Transform for the angular velocity time-domain data.

3. The method of motion trajectory reconstruction of claim 1, wherein the step of transforming the angular velocity frequency-domain data only having the main frequency wave into the angular displacement time-domain data further comprises:
transforming the angular velocity frequency-domain data only having the main frequency wave into the angular displacement time-domain data by using a sine function reconstruction equation, wherein the sine function reconstruction equation is:
$$\frac{A}{ω} sin ( ω t + φ + 90 ° ) ,$$
wherein, A represents an amplitude of the main frequency wave, ω represents a frequency, φ represents a phase, and t represents time,

4. The method of motion trajectory reconstruction of claim 1, wherein the step of obtaining the linear displacement time-domain data by calculating the linear acceleration time-domain data and the angular displacement time-domain data further comprises:
obtaining a quaternion value by substituting the angular displacement time-domain data into a quaternion equation;
obtaining a transition matrix by substituting the quaternion value into a transition matrix equation;
obtaining global coordinate linear acceleration time-domain data by multiplying the linear acceleration time-domain data by the transition matrix; and
obtaining actual global coordinate linear acceleration time-domain data by deducting a gravity acceleration from the global coordinate linear acceleration time-domain data.

5. The method of motion trajectory reconstruction of claim 4, wherein the step of obtaining the linear displacement time-domain data by calculating the linear acceleration time-domain data and the angular displacement time-domain data further comprises:
performing the spectrum analysis to transform the actual global coordinate linear acceleration time-domain data into linear acceleration frequency-domain data, wherein the frequency content and corresponding amplitude and phase information of the linear acceleration frequency-domain data are obtained from the spectrum of the linear acceleration frequency-domain data;
identifying the main frequency wave and the redundant frequency wave in the spectrum of the linear acceleration frequency-domain data and choosing the main frequency wave; and
transforming the linear acceleration frequency-domain data only having the main frequency wave into linear displacement time-domain data.

6. The method of motion trajectory reconstruction of claim 5, wherein the step of transforming the linear acceleration frequency-domain data only having the main frequency wave into the linear displacement time-domain data further comprises:
transforming the linear acceleration frequency-domain data only having the main frequency wave into the linear displacement time-domain data by using a sine function reconstruction equation, wherein the sine function reconstruction equation is:
$$\frac{A}{{ω}^{2}} sin ( ω t + φ + 180 ° ) ,$$
wherein, A represents an amplitude of the main frequency wave, ω represents a frequency, φ represents a phase, and t represents time.

7. The method of motion trajectory reconstruction of claim 4, wherein the step of obtaining the linear displacement time-domain data by calculating the linear acceleration time-domain data and the angular displacement time-domain data further comprises:
performing the spectrum analysis to transform the actual global coordinate linear acceleration time-domain data into linear acceleration frequency-domain data;
transforming the linear acceleration frequency-domain data into linear displacement frequency-domain data;
identifying the main frequency wave and the redundant frequency wave in the spectrum of the linear displacement frequency-domain data and choosing the main frequency wave; and
transforming the linear displacement frequency-domain data only having the main frequency wave into the linear displacement time-domain data.

8. The method of motion trajectory reconstruction of claim 5, wherein the step of performing the spectrum analysis for the actual global coordinate linear acceleration time-domain data further comprises:
performing a discrete Fourier Transform or a discrete Wavelet Transform for the angular velocity time-domain data.

9. The method of motion trajectory reconstruction of claim 7, wherein the step of performing the spectrum analysis for the actual global coordinate linear acceleration time-domain data further comprises:
performing a discrete Fourier Transform or a discrete Wavelet Transform for the angular velocity time-domain data.

10. The method of motion trajectory reconstruction of claim 7, wherein the step of transforming the linear displacement frequency-domain data only having the main frequency wave into the linear displacement time-domain data further comprises:
transforming the linear displacement frequency-domain data only having the main frequency wave into the linear displacement time-domain data by using a sine function reconstruction equation, a discrete Inverse Fourier Transform or a discrete Inverse Wavelet Transform, wherein the sine function reconstruction equation is:
A sin(ωt+φ),
wherein, A represents an amplitude of the main frequency wave, ω represents a frequency, φ represents a phase, and t represents time.

11. A method of motion trajectory reconstruction applied to a motion trajectory reconstruction system, comprising:
obtaining at least angular velocity time-domain data and linear acceleration time-domain data from a traveling inertial sensor;
performing a spectrum analysis to transform the angular velocity time-domain data into angular velocity frequency-domain data;
transforming the angular velocity frequency-domain data into angular displacement frequency-domain data, wherein frequency content and corresponding amplitude and phase information of the angular displacement frequency-domain data are obtained from a spectrum of the angular displacement frequency-domain data;
identifying a main frequency wave and a redundant frequency wave in the spectrum of the angular displacement frequency-domain data and choosing the main frequency wave;
transforming the angular displacement frequency-domain data only having the main frequency wave into the angular displacement time-domain data;
obtaining linear displacement time-domain data by calculating the linear acceleration time-domain data and the angular displacement time-domain data; and
reconstructing and displaying the motion trajectory of the inertial sensor according to the linear displacement time-domain data and the angular displacement time-domain data.

12. The method of motion trajectory reconstruction of claim 11, wherein the step of performing the spectrum analysis for the angular velocity time-domain data further comprises:
performing a discrete Fourier Transform or a discrete Wavelet Transform for the angular velocity time-domain data.

13. The method of motion trajectory reconstruction of claim 11, wherein the step of transforming the angular displacement frequency-domain data only having the main frequency wave into the angular displacement time-domain data further comprises:
transforming the angular displacement frequency-domain data only having the main frequency wave into the angular displacement time-domain data by using a sine function reconstruction equation, a discrete Inverse Fourier Transform or a discrete Inverse Wavelet Transform, wherein the sine function reconstruction equation is:
A sin(ωt+φ)
wherein, A represents an amplitude of the main frequency wave, ω represents a frequency, φ represents a phase, and t represents time.

14. The method of motion trajectory reconstruction of claim 11, wherein the step of obtaining the linear displacement time-domain data by calculating the linear acceleration time-domain data and the angular displacement time-domain data further comprises:
obtaining a quaternion value by substituting the angular displacement time-domain data into a quaternion equation;
obtaining a transition matrix by substituting the quaternion value into a transition matrix equation;
obtaining global coordinate linear acceleration time-domain data by multiplying the linear acceleration time-domain data by the transition matrix; and
obtaining actual global coordinate linear acceleration time-domain data by deducting a gravity acceleration from the global coordinate linear acceleration time-domain data.

15. The method of motion trajectory reconstruction of claim 14, wherein the step of obtaining the linear displacement time-domain data by calculating the linear acceleration time-domain data and the angular displacement time-domain data further comprises:
performing the spectrum analysis to transform the actual global coordinate linear acceleration time-domain data into linear acceleration frequency-domain data, wherein the frequency content and corresponding amplitude and phase information of the linear acceleration frequency-domain data are obtained from the spectrum of the linear acceleration frequency-domain data;
identifying the main frequency wave and the redundant frequency wave in the spectrum of the linear acceleration frequency-domain data and choosing the main frequency wave; and
transforming the linear acceleration frequency-domain data only having the main frequency wave into linear displacement time-domain data.

16. The method of motion trajectory reconstruction of claim 15, wherein the step of transforming the linear acceleration frequency-domain data only having the main frequency wave into the linear displacement time-domain data further comprises;
transforming the linear acceleration frequency-domain data only having the main frequency wave into the linear displacement time-domain data by using a sine function reconstruction equation, wherein the sine function reconstruction equation is:
$$\frac{A}{{ω}^{2}} sin ( ω t + φ + 180 ° )$$
wherein, A represents an amplitude of the main frequency wave, ω represents a frequency, φ represents a phase, and t represents time.

17. The method of motion trajectory reconstruction of claim 14, wherein the step of obtaining the linear displacement time-domain data by calculating the linear acceleration time-domain data and the angular displacement time-domain data further comprises:
performing the spectrum analysis to transform the actual global coordinate linear acceleration time-domain data into linear acceleration frequency-domain data;
transforming the linear acceleration frequency-domain data into linear displacement frequency-domain data;
identifying the main frequency wave and the redundant frequency wave in the spectrum of the linear displacement frequency-domain data and choosing the main frequency wave;
transforming the linear displacement frequency-domain data only having the main frequency wave into the linear displacement time-domain data.

18. The method of motion trajectory reconstruction of claim 15, wherein the step of performing the spectrum analysis for the actual global coordinate linear acceleration time-domain data further comprises:
performing a discrete Fourier Transform or a discrete Wavelet Transform for the actual global coordinate linear acceleration time-domain data.

19. The method of motion trajectory reconstruction of claim 17, wherein the step of performing the spectrum analysis for the actual global coordinate linear acceleration time-domain data further comprises:
performing a discrete Fourier Transform or a discrete Wavelet Transform for the actual a global coordinate linear acceleration time-domain data.

20. The method of motion trajectory reconstruction of claim 17, wherein the step of transforming the linear displacement frequency-domain data only having the main frequency wave into the linear displacement time-domain data further comprises:
transforming the linear displacement frequency-domain data only having the main frequency wave into the linear displacement time-domain data by using a sine function reconstruction equation, a discrete Inverse Fourier Transform or a discrete Inverse Wavelet Transform, wherein the sine function reconstruction equation is:
A sin(ωt+φ)
wherein, A represents an amplitude of the main frequency wave, ω represents a frequency, φ represents a phase, and t represents time.

21. A non-transitory computer readable recording medium, provided with a computer program, used for processing a method of motion trajectory reconstruction of claim 1.

22. A non-transitory computer readable recording medium, provided with a computer program, used for processing a method of motion trajectory reconstruction of claim 11.

23. A system of motion trajectory reconstruction, comprising:
multiple inertial sensors, each used for collecting at least angular velocity time-domain data and linear acceleration time-domain data;
a men; and
a computer device, electrically connected to the inertial sensors and the screen for obtaining the angular velocity time-domain data and the linear acceleration time-domain data from traveling inertial sensors; performing a spectrum analysis to transform each of the angular velocity time-domain data into angular velocity frequency-domain data; identifying a main frequency wave and a redundant frequency wave in a spectrum of frequency-domain data and choosing the main frequency wave, wherein the frequency-domain data is angular velocity frequency-domain data or angular displacement frequency-domain data transformed from the angular velocity frequency-domain data; transforming the angular velocity frequency-domain data only having the main frequency wave or the angular displacement frequency-domain data into angular displacement time-domain data; obtaining linear displacement time-domain data by calculating the linear acceleration time-domain data and the angular displacement time-domain data; and reconstructing and displaying the motion trajectories of the inertial sensors on the screen according to the linear displacement time-domain data and the angular displacement time-domain data.
